(19) United States
(12) Patent Application Publication
(10) Pub. No.: US 2008/0081002 A1
(43) Pub. Date: Apr. 3, 2008

(54) Diagnostic assay reader having multiple power configurations

(76) Inventors: Patrick Petruno, San Jose, CA (US); Daniel B. Roitman, Menlo Park, CA (US); John F. Petrilla, Palo Alto, CA (US); Rene P. Helbing, Palo Alto, CA (US); Cynthia Sue Mitchell, Windsor, CO (US); Ian Hardcastle, Sunnyvale, CA (US)

Correspondence Address: Kathy Manke;Avago Technologies Limited, 4380 Ziegler Road, Fort Collins, CO, 80525, US

(21) Appl. No.: 11/541,020

(22) Filed: Sep. 29, 2006

(51) Int. Cl. G01N 21/00

(52) U.S. Cl. 422/82.05

(57) ABSTRACT

A diagnostic assay reader includes a detector configured to read a diagnostic assay result and develop a result signal that is indicative of the result, a processor configured to process the result signal, and an external power interface connected to the detector and to the processor, the external power interface configured to receive external power for the diagnostic assay reader.

### BACKGROUND

Rapid diagnostic assay test kits are in widespread use for analyzing substances. A diagnostic assay refers to a qualitative or quantitative test of a substance to determine its components. A diagnostic assay test kit is frequently used to test for the presence or concentration of infectious agents or antibodies, etc. Diagnostic assay test kits are available to test for pregnancy, ovulation, the presence of HIV, influenza, alcohol, drugs, and other substances. Some of these test kits are designed to be discarded after a single use and others are designed to be used repeatedly before being discarded. Regardless of the type of test performed or whether the test kit is designed for single or multiple use, the test kit typically includes a battery powered diagnostic assay reader. The battery is typically installed in the diagnostic assay reader at the time of manufacture. Unfortunately, batteries suffer from shortcomings such as a limited shelf life and degraded test capability as the battery power declines. Another shortcoming is that batteries are relatively costly.

Therefore, it would be desirable to have a diagnostic assay reader that overcomes these shortcomings.

### SUMMARY

In an embodiment, a diagnostic assay reader includes a detector configured to read a diagnostic assay result and develop a result signal that is indicative of the result, a processor configured to process the result signal, and an external power interface connected to the detector and to the processor, the external power interface configured to receive external power for the diagnostic assay reader.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an embodiment of a diagnostic assay reader.

FIG. 2 is a flowchart showing the operation of an embodiment of the diagnostic assay reader of FIG. 1.

FIG. 3 is a block diagram showing an alternative embodiment of the diagnostic assay reader of FIG. 1.

FIG. 4 is a block diagram showing another alternative embodiment of the diagnostic assay reader of FIG. 1.

FIG. 5 is a block diagram illustrating another alternative embodiment of a diagnostic assay reader.

FIG. 6 is a flowchart showing the operation of an embodiment of the diagnostic assay reader of FIG. 5.

FIG. 7 is a schematic diagram showing a diagnostic assay reader that includes a mechanism for generating energy to power the diagnostic assay reader.

### DETAILED DESCRIPTION

Embodiments of the diagnostic assay reader to be described below will be described in the context of optically reading a diagnostic assay result. However, the diagnostic assay reader can be used in implementations that read a diagnostic assay result using technology other than an optical reader.

The diagnostic assay reader to be described below is generally intended to be operated by a medical caregiver and used at a point-of-care location. However, other implementations are possible.

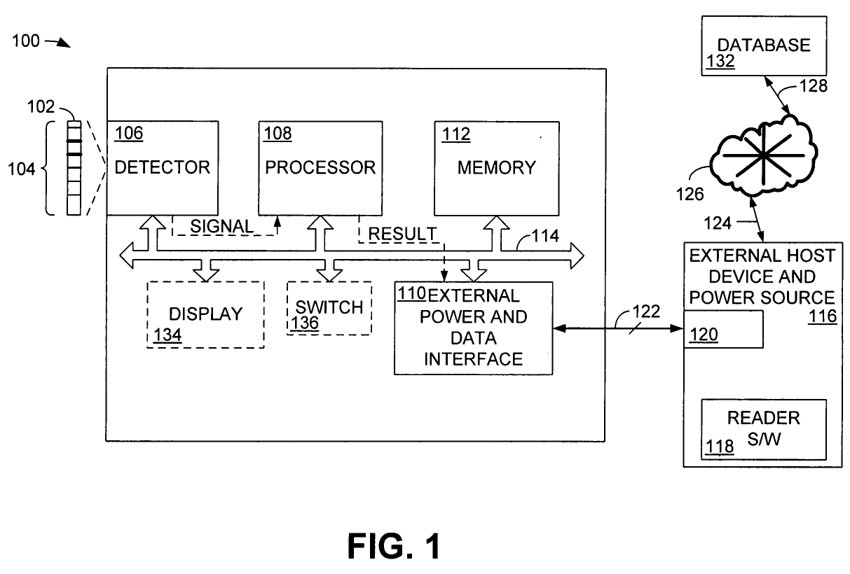

FIG. 1 is a block diagram illustrating an embodiment of a diagnostic assay reader. The diagnostic assay reader 100 generally includes a detector 106, a processor 108 and a memory element 112 connected via a communication and power bus 114. The detector 106 can be an optical sensor such as an image sensor or a PIN diode, an electrical detector, an electrochemical detector, or any other sensor that can interpret a diagnostic assay result. The processor 108 can be a microprocessor, a state machine, hard wired logic, or can be implemented using discrete components, such as an operational amplifier configured as a comparator. In an embodiment, the diagnostic assay reader 100 also includes an external power and data interface 110. The external power and data interface 110 is connected to an external host device and power source 116 via connection 122. In an embodiment, the external power and data interface 110 complies with the universal serial bus (USB) standard and provides a USB interface, which allows the diagnostic assay reader 100 to be connected to and receive power from an external computing device, such as the external host device and power source 116. In an alternative embodiment, the functionality of the external power and data interface 110 may be provided by separate power and data interfaces.

The external host device and power source 116 also includes an external power and data interface 120 that couples via connection 122 to the external power and data interface 110. In this embodiment, the external power and data interface 120 also complies with the USB standard and allows the transfer of power and data between the diagnostic assay reader 100 and the external host device and power source 116. However, the diagnostic assay reader 100 can include data and power interfaces other than USB. For example, the diagnostic assay reader 100 can be powered by a serial interface. The external host device and power source 116 also includes reader software 118. The reader software 118 provides a user interface on the external host device and power source 116 for the diagnostic assay reader 100.

The diagnostic assay reader 100 optionally includes a display 134 and a power switch 136. In some applications, it is not desirable for the results of the diagnostic assay to be readily evident on the diagnostic assay reader 100. In such implementations, the display 134 is omitted. Further, instead of a communications and power bus 114, the detector 106, processor 108, memory element 112 and the external power and data interface 110 can be connected using discrete connections.

In an embodiment, the detector 106 is an image sensor, such as a silicon complementary metal oxide semiconductor (CMOS) image sensor capable of electronically reading a diagnostic assay result 102 that is placed or otherwise located in a field of view of the detector 106 or connected to the detector 106. The diagnostic assay result 102 can be, for example, a chemically activated visual indicator of a diagnostic assay or can be an electrochemical reaction. The diagnostic assay result 102 is machine-readable to minimize the occurrence of errors when interpreting the result. For example, the diagnostic assay result 102 may include one or more indicator bars 104, the presence or absence, location, color, intensity, etc., of which convey the result of a diagnostic assay. In an embodiment, the detector 106 is placed in proximity to the diagnostic assay result 102 so that the detector 106 can electronically read and image the bars 104. In an embodiment in which the detector 106 is an image detector, the detector 106 generates an image of the diagnostic assay result. A signal indicative of an electronic representation of the image is then transferred from the detector 106 to the processor 108 via the communication and power bus 114. In an alternative embodiment, the detector 106 can be implemented using a PIN diode, or an array of PIN diodes, to sense the state of the diagnostic assay result. The PIN diode senses the optical intensity of a signal and converts the optical intensity signal to an electrical signal. The output of the PIN diode can be transferred to the processor 108, which can be implemented using an operational amplifier configured as a comparator. The signal from the PIN diode is compared against a threshold value supplied to the comparator to determine the state of the diagnostic assay result 102. The output of the comparator is provided to the memory 112 and to the external power and data interface 110 via the communication and power bus 114. This embodiment will be described below. When the detector is implemented as an imaging device or a PIN diode, a light emitting diode (LED) or laser can be used to illuminate the diagnostic assay result.

Alternatively, the detector 106 can be an electrical sensor if the diagnostic assay result 102 is provided using an electrochemical reaction. In another alternative embodiment in which the diagnostic assay result 102 is provided using an electrochemical reaction, the detector 106 can be implemented using a detector and electrical probes that contact fluid-covered electrical contacts associated with the diagnostic assay result. The electrical signal detected by the electrical probes is representative of the result of the diagnostic assay. The result signal is communicated to the processor 108, which can be implemented using an operational amplifier configured as a comparator. The signal from the electrical probes is compared against a threshold value supplied to the comparator to determine the state of the diagnostic assay result 102. The output of the comparator is provided to the memory 112 and to the external power and data interface 110 via the communication and power bus 114. This embodiment will be described below. If the detector 106 is implemented using one or more PIN diodes or electrical probes, multiple lines, also referred to as detection zones, on the diagnostic assay result can be detected using multiple channels. In such an implementation, the PIN diode or electrical probe will typically be an array of PIN diodes or electrical probes. Alternatively if a single channel is implemented, the diagnostic assay result can be mechanically moved or, in the case of a PIN diode, the field of view of the PIN diode can be optically steered to read the diagnostic assay result.

The processor 108 analyzes the electronic representation of the image and develops a result signal that is indicative of the diagnostic assay result. The result signal can be transferred to the external power and data interface 110 for transmission via power and data connection 122 to the external host device 116.

The result signal can also be stored in the memory element 112 and optionally displayed on the display 134.

The external host device and power source 116 can be coupled to a database 132 via a network 126 and connections 124 and 128. The network 126 can be a local area network or a wide area network, or can be collection of networks such as the World Wide Web (WWW). The connections 124 and 128 can be any connections used to couple devices to a network. Alternatively, the external host device and power source 116 can be coupled directly to the database 132.

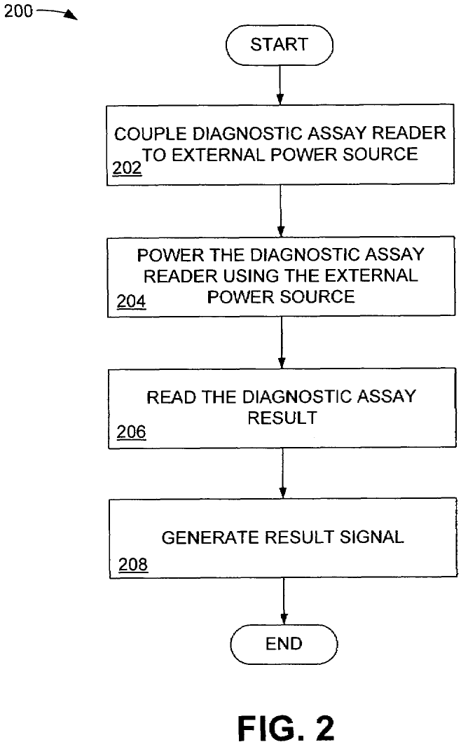

FIG. 2 is a flowchart showing the operation of an embodiment of the diagnostic assay reader 100 of FIG. 1. In block 202, the diagnostic assay reader 100 is coupled to the external host device and power source 116 via the interfaces 110 and 120 (FIG. 1) and connection 122 (FIG. 1). In block 204, the diagnostic assay reader 100 is powered using the external host device and power source 116. In block 206, the diagnostic assay reader 100 reads the diagnostic assay result 102 (FIG. 1). In block 208, the diagnostic assay reader 100 generates a result signal.

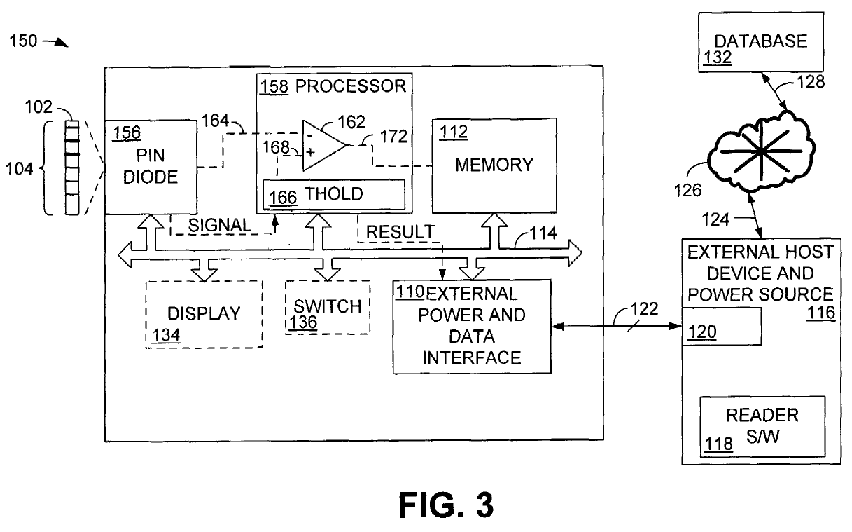

FIG. 3 is a block diagram showing an alternative embodiment of the diagnostic assay reader of FIG. 1. The elements of the diagnostic assay reader 150 that are common to the diagnostic assay reader 100 are identically numbered and will not be described again in detail.

The diagnostic assay reader 150 includes a detector implemented using a PIN diode 156. However, an array of PIN diodes may be implemented. The PIN diode 156 senses the state of the diagnostic assay result 102. The PIN diode 156 senses the optical intensity of the diagnostic assay result 102 and converts the optical intensity signal to an electrical signal. The output of the PIN diode 156 is transferred to the processor 158 via connection 164. However, in an alternative implementation, the output of the PIN diode 156 can be transferred to the processor 158 over the communication and power bus 114.

In this embodiment, the processor 158 is implemented using an operational amplifier configured as a comparator 162. The signal from the PIN diode 156 is compared against a threshold value 166 supplied to the comparator 162 via connection 168 to determine the state of the diagnostic assay result 102. Although shown as residing within the processor 158, the threshold element 166 may reside elsewhere. The output of the comparator 162 is provided via connection 172 to the memory 112 and to the external power and data interface 110 via the communication and power bus 114.

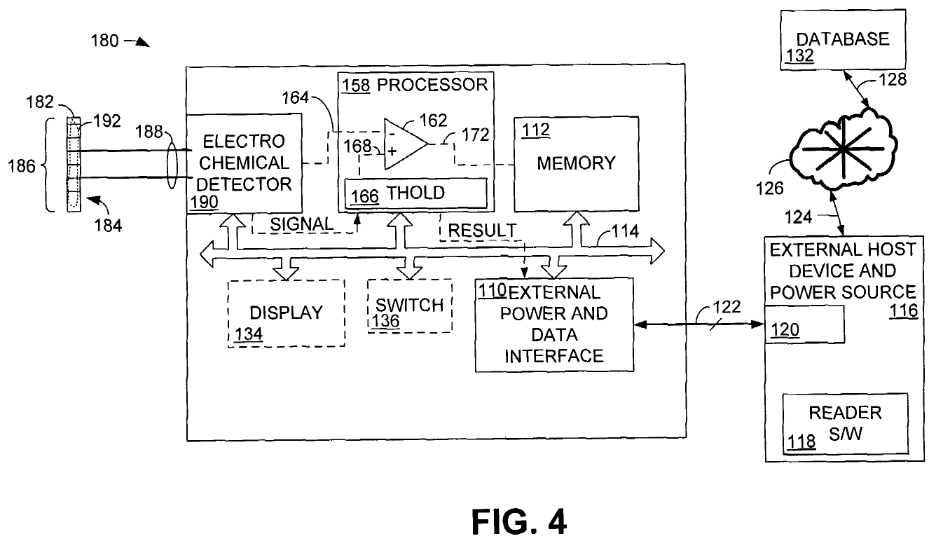

FIG. 4 is a block diagram illustrating another alternative embodiment of the diagnostic assay reader of FIG. 1. The elements of the diagnostic assay reader 180 that are common to the diagnostic assay reader 100 are identically numbered and will not be described again in detail.

The diagnostic assay reader 180 includes a detector implemented using an electrochemical detector 190. In this embodiment, a diagnostic assay result 182 is an electrochemical device in which a test area 184 includes electrical contacts 186 that are covered by a fluid 192. The fluid has electrical impedance. The fluid 192 is electrically stimulated and detected using the probes 188 associated with the electrochemical detector 190. The impedance is proportional to the concentration of analyte in the fluid 192.

The electrical probes 188 are electrically connected to the electrical contacts 186 through the fluid 192 and can sense electrical fluctuations in the fluid 192 in the test area 184. The electrical fluctuations are sensed by the electrical probes 188 and converted to an electrical signal by the electrochemical detector 190. The electrical signal is indicative of the state of the diagnostic assay result 182. The signal is transferred from the electrochemical detector 190 to the processor 158 via connection 164. However, in an alternative implementation, the signal supplied by the electrochemical detector 190 is transferred to the processor 158 over the communication and power bus 114.

In this embodiment, the processor 158 is implemented using an operational amplifier configured as a comparator 162. The signal from the electrochemical detector 190 is compared against a threshold value 166 supplied to the comparator 162 via connection 168 to determine the state of the diagnostic assay result 182. Although shown as residing within the processor 158, the threshold element 166 may reside elsewhere. The output of the comparator 162 is provided via connection 172 to the memory 112 and to the external power and data interface 110 via the communication and power bus 114.

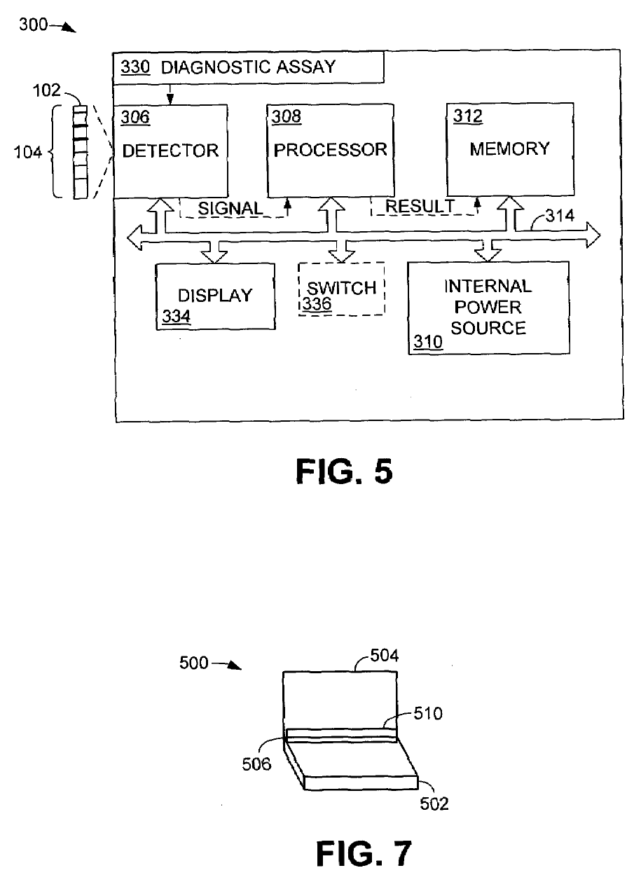

FIG. 5 is a block diagram illustrating another alternative embodiment of a diagnostic assay reader. The diagnostic assay reader 300 generally includes a detector 306, a processor 308 and a memory element 312 connected via a communication and power bus 314. The detector 306 can be an optical sensor such as an image sensor or a PIN diode, an electrical detector, an electrochemical detector, or any other sensor that can interpret a diagnostic assay result. The processor 308 can be a microprocessor, a state machine, hard wired logic, or can be implemented using discrete components, such as an operational amplifier configured as a comparator. In accordance with this embodiment, the diagnostic assay reader 300 also includes an internal power source 310. The internal power source 310 provides power to the diagnostic assay reader 300 using, for example, a piezoelectric power generator, a microelectronic mechanical system (MEMS) electrostatic power source, a kinetic energy storage and power generation device, a hand crank, or another power source that does not rely on conventional battery technology. A piezoelectric micro power generator is described in Micro power sources for autonomous Wireless Microsystems, Y. Ammar, S. Basrour, B. Charlot and M. Marzencki, TIMA laboratory, MNS Group 2005, which is incorporated herein by reference. A MEMS electrostatic micro power generator is described in MEMS electrostatic micropower generator for low frequency operation, P. D. Mitcheson, P. Miao, B. H. Stark, E. M. Yeatman, A. S. Holmes and T. C. Green, Department of Electrical and Electronic Engineering, Imperial College London, London UK, Sensors and Actuators A 115 (2004), which is incorporated herein by reference.

The internal power source 310 provides power to the diagnostic assay reader 300 using one of a number of different technologies. For example, in addition to the power sources mentioned above, the internal power source 310 can be formed as part of a hinge or spring if the diagnostic assay reader 300 is formed as a so called “clamshell” shaped device. In such an embodiment, opening or closing the clamshell device generates energy to power the diagnostic assay reader 300.

The diagnostic assay reader 300 includes a display 334 and an optional power switch 336. Alternatively, instead of a communications and power bus 314, the detector 306, processor 308, memory element 312 and the internal power source 310 can be connected using discrete connections.

The detector 306 can be an image sensor that is similar to the detector 106 described above. The detector 306 reads a diagnostic assay result 102 that is placed in a field of view of the detector 306 or that is otherwise connected to the detector 306. Alternatively, the detector 306 can be an electrochemical detector if the diagnostic assay result is provided using an electrochemical reaction, as described above. An electronic representation of the image is then transferred from the detector 306 to the processor 308 via the communication and power bus 314. The processor 308 analyzes the electronic representation of the image and develops a result signal that is indicative of the diagnostic assay result. The result signal can be stored in the memory element 312 and displayed to a user on the display 334. Alternatively, the diagnostic assay reader 300 is part of a self contained diagnostic assay test kit that includes a diagnostic assay 330. In such an implementation, the diagnostic assay 330 can be internally connected to and read by the detector 306. Alternatively, the detector 306 can be any sensor device capable of interpreting the result of the diagnostic assay 330.

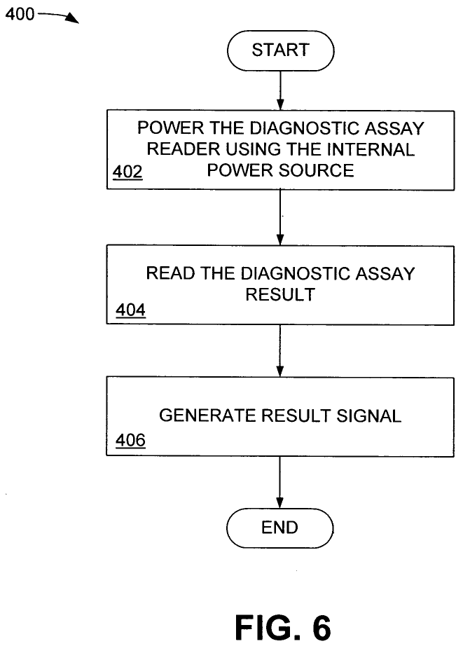

FIG. 6 is a flowchart showing the operation of an embodiment of the diagnostic assay reader of FIG. 5. In block 402, the diagnostic assay reader 300 is powered by the internal power source 310. In block 404, the diagnostic assay reader 300 reads the diagnostic assay result 102 (FIG. 5). In block 406, the diagnostic assay reader 300 generates a result signal and transfers the result signal to the display 334.

FIG. 7 is a schematic diagram showing a diagnostic assay reader that includes a mechanism for generating energy to power the diagnostic assay reader. The diagnostic assay reader 500 is similar to the diagnostic assay reader 300 of FIG. 5. In the embodiment shown in FIG. 7, the diagnostic assay reader 500 is formed as a “clamshell” device that includes a base 502, a lid 504 and a hinge 506 that joins the base 502 and the lid 504. Opening, closing or a combination of opening and closing the lid 504 actuates the hinge 506. In an embodiment, the diagnostic assay reader 500 includes an energy converter 510 coupled to the hinge 506. The energy converter 510 converts the opening and closing motion of the hinge 506 into electrical energy to power the diagnostic assay reader 500. Although described using the hinge 506, many other structures can be used to generate mechanical motion and convert the mechanical motion into energy that can power the diagnostic assay reader 500. Alternatively, other power sources that do not rely on conventional battery technology n be used to power the diagnostic assay reader 500.

This disclosure describes the invention in detail using illustrative embodiments. However, it is to be understood that the invention defined by the appended claims is not limited to the precise embodiments described.

What is claimed is:

1. A diagnostic assay reader, comprising:
a detector configured to read a diagnostic assay result and develop a result signal that is indicative of the result;
a processor configured to process the result signal; and
an external power interface connected to the detector and to the processor, the external power interface configured to receive external power for the diagnostic assay reader.

2. The diagnostic assay reader of claim 1, wherein the external power interface is a universal serial bus (USB) interface and wherein the USB interface further provides a data interface.

3. The diagnostic assay reader of claim 1, wherein the diagnostic assay reader is a point-of-care device.

4. The diagnostic assay reader of claim 1, further comprising a memory element configured to store the result signal.

5. The diagnostic assay reader of claim 1, further comprising a display configured to display the result to a user.

6. The diagnostic assay reader of claim 1, in which the diagnostic assay reader is disposable.

7. The diagnostic assay reader of claim 1, further comprising a computing device coupled via the external power interface and the data interface, the computing device configured to receive the result signal.

8. A method for operating a diagnostic assay reader, the method comprising:
coupling the diagnostic assay reader to an external power source via an external power interface;
powering the diagnostic assay reader using the external power source; and
reading a diagnostic assay result using the diagnostic assay reader.

9. The method of claim 8, further comprising:
providing an external data interface;
developing a result signal in the diagnostic assay reader; and
transferring the result signal to an external computing device via the external data interface.

10. The method of claim 9, further comprising storing the result signal in the diagnostic assay reader.

11. The method of claim 9, further comprising displaying the result signal on the diagnostic assay reader.

12. The method of claim 8, further comprising discarding the diagnostic assay reader after a predetermined number of uses.

13. The method of claim 8, wherein the reading comprises optically reading the diagnostic assay result.

14. A diagnostic assay reader, comprising:
a detector configured to read a diagnostic assay result and develop a result signal that is indicative of the result;
a processor configured to process the result signal; and
an external power and data interface connected to the detector and to the processor, the external power and data interface configured to receive external power for and provide a data connection to the diagnostic assay reader, wherein the diagnostic assay reader is a point-of-care device and is disposable.

15. The diagnostic assay reader of claim 14, wherein the detector is chosen from an optical sensor and an electrical sensor.

16. The diagnostic assay reader of claim 15, wherein the external power and data interface is a universal serial bus (USB) interface.

17. The diagnostic assay reader of claim 16, further comprising a memory element configured to store the result signal.

18. The diagnostic assay reader of claim 17, further comprising a computing device coupled via the external power and data interface, the computing device configured to receive the result signal.

19. The diagnostic assay reader of claim 18, further comprising a display configured to display the result to a user.

20. The diagnostic assay reader of claim 19, in which the diagnostic assay reader is portable.

21. A diagnostic assay reader, comprising:
a detector configured to read a diagnostic assay result and develop a result signal that is indicative of the result;
a processor configured to process the result signal; and
an internal power source connected to the image sensor and to the processor, the internal power source configured to provide power to the diagnostic assay reader without a battery.
